(19) United States
(12) Patent Application Publication
(10) Pub. No.: US 2017/0030857 A1
(43) Pub. Date: Feb. 2, 2017

(54) SENSOR ELEMENT FOR ACQUIRING AT LEAST ONE PROPERTY OF A MEASUREMNT GAS IN A MEASUREMENT GAS COMPARTMENT, AND METHOD FOR THE PRODUCTION THEREOF

(71) Applicant: Robert Bosch GmbH, Stuttgart (DE)

(72) Inventor: Daniel Pantel, Ditzingen (DE)

(21) Appl. No.: 15/214,057

(22) Filed: Jul. 19, 2016

(30) Foreign Application Priority Data
Jul. 29, 2015 (DE) 102015214387.2

(51) Int. Cl. G01N 27/407

(52) U.S. Cl. CPC G01N 27/4073; G01N 27/4071

(57) ABSTRACT

A sensor element for acquiring at least one property of a measurement gas in a measurement gas compartment, in particular for acquiring a portion of a gas component in the measurement gas or a temperature of the measurement gas, includes a bearer element and at least one solid electrolyte layer. The solid electrolyte layer is situated on the bearer element. The solid electrolyte layer is at least partially epitaxially fashioned. The bearer element has at least one opening, so that the solid electrolyte layer has at least one membrane segment. In addition, a method is provided for producing such a sensor element.

### RELATED APPLICATION INFORMATION

The present application claims priority to and the benefit of German patent application no. 10 2015 214 387.2, which was filed in Germany on Jul. 29, 2015, the disclosure of which is incorporated herein by reference.

### FIELD OF THE INVENTION

The present invention relates to a sensor element for acquiring at least one property of a measurement gas in a measurement gas compartment, in particular for acquiring a portion of a gas component in the measurement gas or a temperature of the measurement gas, which includes a bearer element and at least one solid electrolyte layer, and a method related thereto.

### BACKGROUND INFORMATION

From the existing art, a large number of sensor elements and methods for acquiring at least one property of a measurement gas in a measurement gas compartment are known. These can be in principle any physical and/or chemical properties of the measurement gas, and one or more properties can be acquired. In the following, the present invention is described in particular with reference to a qualitative and/or quantitative acquisition of a portion of a gas component of the measurement gas, in particular with reference to an acquisition of an oxygen portion in the measurement gas portion. The oxygen portion can for example be acquired in the form of a partial pressure and/or in the form of a percentage. Alternatively or in addition, however, other properties of the measurement gas can also be acquired, such as the temperature.

From the existing art, in particular ceramic sensor elements are known that are based on the use of electrolytic properties of particular solid bodies, i.e. ion-conducting properties of these solid bodies. In particular, these solid bodies can be ceramic solid electrolytes, such as zirconium dioxide (ZrO₂), in particular yttrium-stabilized zirconium dioxide (YSZ) and scandium-doped zirconium dioxide (ScSZ), which can contain small added amounts of aluminum oxide (Al₂O₃) and/or silicon oxide (SiO₂)

For example, such sensor elements can be fashioned as so-called lambda sensors or as nitrogen oxide sensors, as known for example from K. Reif, Deitsche, K.-H., et al., Kraftfahrtechnisches Taschenbuch, Springer Vieweg, Wiesbaden (2014), pp. 1338-1347. Using broadband lambda sensors, in particular planar broadband lambda sensors, for example the oxygen concentration in the exhaust gas can be determined within a wide range, and in this way the air-fuel ratio in the combustion chamber can be inferred. The air number λ (lambda) describes this air-fuel ratio. Nitrogen oxide sensors determine both the nitrogen oxide concentrations and also the oxygen concentration in the exhaust gas.

Despite the advantages of the sensor elements known from the existing art, and methods for producing them, there is still potential for improvement here. Thus, the sensor element is standardly produced using the so-called ceramic thick-layer technique. This technique permits only large minimum dimensions, both with regard to the structural widths of standardly at least 30 μm and also given layer thicknesses of standardly more than 10 μm. For this reason, microelectrochemical elements have been developed. Here, a solid body electrolyte in the form of a thin layer is used. The deposition of YSZ as a thin film for gas sensor elements or microfuel cells (μ-SOFC) is nowadays done on silicon nitride (Si₃N₄) or SiO₂. Both can also be used non-stoichiometrically, and are amorphous. Here, Si₃N₄ or SiO₂ is used as an electrical insulator that separates the solid body electrolytes from silicon. Silicon has good electrical conductivity at high temperatures. The growth of YSZ on these scaffoldings or templates is polycrystalline, and, depending on the growth conditions or deposition parameters, is for example granular or columnar. Granular growth results in a low ionic conductivity, and column growth results in a mechanically unstable membrane, because the YSZ is often “exposed” so that gas access can be ensured to the two surfaces of the YSZ layer given tensile-stress mechanical loading, and results in poor ionic conductivity perpendicular to the columns.

### SUMMARY OF THE INVENTION

Therefore, a sensor element for acquiring at least one property of a measurement gas in a measurement gas compartment, and a method for the production thereof, are proposed, that at least largely avoid the disadvantages of known sensor elements and methods, and permit the production of a mechanically robust thin membrane having very good ion conductivity.

A sensor element for acquiring at least one property of a measurement gas in a measurement gas compartment, in particular for acquiring a portion of a gas component in the measurement gas or a temperature of the measurement gas, includes a bearer element and at least one solid electrolyte layer, the solid electrolyte layer being situated on the bearer element, the solid electrolyte layer being at least partly epitaxially fashioned, the bearer element having at least one opening, so that the solid electrolyte layer has at least one membrane segment.

The solid electrolyte layer can have a thickness of from 40 nm to 5 μm, which may be 50 nm to 3 μm, and more particularly 200 nm to 2 μm, for example 1 μm. Correspondingly, the solid electrolyte layer can be realized significantly thinner in comparison to conventional ceramic sensor elements. In this way, the sensor element of the present invention can be produced smaller as a whole, and can also be used in spatially constricted locations. Between the solid electrolyte layer and the bearer element, in some sections at least one insulating layer can be situated, the insulating layer being produced of at least one electrically insulating material, in particular Si₃N₄ and/or SiO₂. Between the solid electrolyte layer and the bearer element there can be situated at least one intermediate layer, the intermediate layer being fashioned epitaxially and so as to be oxidic, electrically conductive, and gas-permeable, or the intermediate layer being fashioned epitaxially and so as to be oxidic and electrically insulating. The solid electrolyte layer can be produced from at least one material that includes zirconium dioxide stabilized with yttrium oxide. A portion of the yttrium oxide can have a gradient on the zirconium dioxide, which may be perpendicular to a layer plane of the solid electrolyte layer. Thus, the zirconium dioxide is stabilized with yttrium oxide in order to improve the material strength and to set, or adapt, the ionic conductivity. Via the gradient, a kind of transition can be created from the ionically conductive material of the solid electrolyte layer to the material of the electrodes, which is electrically conductive but has an increased electrolyte resistance. The solid electrolyte layer can have, in the membrane segment, an opening on a side facing the bearer element. On an upper side, facing away from the bearer element, of the solid electrolyte layer, and on a lower side, facing the bearer element, of the solid electrolyte layer, in each case there can be situated an electrode. The electrodes may be porous. The porosity of the electrodes is selected such that on the one hand the measurement gas, or the ions of the measurement gas, such as oxygen ions, move through the electrodes to the solid electrolyte layer, and on the other hand a contiguous electrically conductive structure of the electrode has to be present. The electrodes can be electrically contactable from the same side. In other words, an electrical contacting of the electrodes can take place from one and the same direction. The membrane segment can be fashioned to separate two different measurement gas compartments from one another. The electrodes can in this way be oriented toward two different measurement gas compartments, or can be exposed to these compartments.

The method for producing a sensor element for acquiring at least one property of a measurement gas in a measurement gas compartment, in particular for acquiring a portion of a gas component in the measurement gas or a temperature of the measurement gas, includes the provision of a bearer element, the application of at least one solid electrolyte layer onto the bearer element in such a way that the solid electrolyte layer is epitaxially fashioned, and the partial removal of the bearer element in order to form at least one opening in such a way that the solid electrolyte layer has at least one membrane segment.

Here, the solid electrolyte layer can be applied onto the bearer element using pulsed laser deposition, chemical vapor deposition, or sputtering. The solid electrolyte layer can be applied onto the bearer element at a temperature from 600° C. to 1000° C. and a pressure of not more than 0.05 mbar.

The partial removal of the bearer element can be accomplished by trenching or etching. The solid electrolyte layer can be applied onto the bearer element in a thickness of from 40 nm to 5 μm, which may be 50 nm to 3 μm, particularly 200 nm to 2 μm, e.g. in a thickness of 1 μm. Between the solid electrolyte layer and the bearer element, in some segments at least one insulating layer can be situated, the insulating layer being made of at least one electrically insulating material, in particular Si₃N₄ and/or SiO₂. Between the solid electrolyte layer and the bearer element, there can be situated at least one intermediate layer, the intermediate layer being formed epitaxially and so as to be oxidic, electrically conductive and gas-permeable, or the intermediate layer can be fashioned epitaxially and so as to be oxidic and electrically insulating. The solid electrolyte layer can be produced from at least one material that includes zirconium dioxide stabilized with yttrium oxide. The solid electrolyte layer can be applied onto the bearer element in such a way that a portion of the yttrium oxide on the zirconium dioxide has a gradient, which may be perpendicular to a layer plane of the solid electrolyte layer. The solid electrolyte layer can be partly removed in the membrane segment in such a way that an opening is fashioned on a side facing the bearer element.

In the context of the present invention, a solid electrolyte is to be understood as a body or object having electrolyte properties, i.e. ion-conducting properties.

This also includes the raw material of a solid electrolyte, and thus its formation as a so-called green part or brown part, which does not become a solid electrolyte until after a sintering. In particular, the solid electrolyte can be fashioned as a solid electrolyte layer or from a plurality of solid electrolyte layers. In the context of the present invention, a layer is to be understood as a unified mass having a flat extension of a certain height that is situated above, underneath, or between other elements. A layer is thus a three-dimensional body whose measurements in two dimensions, which represent the surface formation of the layer, are significantly larger than a measurement in the third dimension, representing the height of the layer. Correspondingly, in the context of the present invention a layer plane is to be understood as a plane of the layer that represents the surface extension. Thus, in the context of the present invention an orientation perpendicular to the layer plane is an orientation perpendicular to the surface extension of the layer, and an orientation parallel to the layer plane is an orientation parallel to the surface extension of the layer.

In the context of the present invention, an electrode is to be understood in general as an element that is capable of contacting the solid electrolyte in such a way that a current can be maintained through the solid electrolyte and the electrode. Correspondingly, the electrode can include an element at which the ions can be built into the solid electrolyte and/or removed from the solid electrolyte. Typically, the electrodes include a noble metal electrode, which can be applied on the solid electrolyte for example as a metal-ceramic electrode, or can be connected to the solid electrolyte in some other way. Typical electrode materials are platinum-cermet electrodes. Other noble metals, such as gold or palladium, can however also be used in principle.

In the context of the present invention, a heating element is to be understood as an element that is used to heat the solid electrolyte and the electrodes at least to their functional temperature, and which may be to their operating temperature. The functional temperature is the temperature starting at which the solid electrode becomes conductive for ions; it is approximately 350° C. To be distinguished from this is the operating temperature, which is the temperature at which the sensor element is standardly operated, and which is higher than the functional temperature. The operating temperature can be for example from 700° C. to 950° C. The heating element can include a heating region and at least one conducting path. In the context of the present invention, a heating region is to be understood as the region of the heating element that, in the layer construction, overlaps with an electrode along a direction perpendicular to the surface of the sensor element. Standardly, the heating region heats up more strongly during operation than does the conducting path, so that these can be distinguished. The different heating can for example be realized in that the heating region has a higher electrical resistance than does the conducting path. The heating region and/or the conducting path are for example fashioned as electrical resistance paths, and are heated through application of an electrical voltage. The heating element can for example be produced from a platinum cermet or a platinum layer.

In the context of the present invention, an epitaxial formation is to be understood as a formation in which at least one crystallographic orientation of the applied material corresponds to a crystallographic orientation of the bearer element.

A basic idea of the present invention is the production of an epitaxial YSZ layer on a silicon layer, subsequently to be removed, as a solid electrolyte for use for oxygen sensors or a microfuel cell, in which the yttrium oxide content is less than 10 mol % and the layer thickness is typically from 50 nm to 3 μm. For this purpose, YSZ is deposited on a crystalline silicon surface, for example using laser beam vaporization, with low background O₂ partial pressure, i.e. less than 0.05 mbar, and a high substrate temperature, i.e. greater than 600° C. Given suitable deposition parameters, the yttrium-stabilized zirconium dioxide grows epitaxially on the silicon. The silicon is subsequently selectively removed at least at some locations under the YSZ layer, for example through trenching or etching using caustic potash.

Through selective removal of the silicon at particular locations, the growth of epitaxial YSZ directly on the silicon surface is achieved, with subsequent exposure of the YSZ layer.

In another specific embodiment, SiO₂ and/or Si₃N₄ can be applied as insulating layer at locations of the sensor at which the ion-conductive properties of YSZ are not required or not desired.

In a further specific embodiment, the yttrium-stabilized zirconium dioxide layer can be sealed or reinforced after exposure through an insulating layer, for example made of silicon dioxide (SiO₂) or silicon nitride (Si₃N₄). This is advantageous in particular when ion conductivity parallel to the layer is necessary.

In addition, epitaxially yttrium-stabilized zirconium dioxide can be grown on silicon with one or more epitaxial, oxidic, electrically conductive, ion-conducting intermediate layers, for example made of La_{0.6}Sr_{0.4}Co_{0.2}Fe_{0.8}O_{3-δ} (LSCF), Sm_{0.5}Sr_{0.5}CoO₃ (SSC), La₁₋ₓSrₓMnO₃ (LSMO), and these intermediate layer(s) can be contacted by metal electrodes. The intermediate layers can be gas-permeable, alternatively or in addition to their ion-conducting property.

In still another specific embodiment, the epitaxial yttrium-stabilized zirconium dioxide is grown on silicon with one or more epitaxial, oxidic, electrically insulating intermediate layers. In this way, a better electrical insulation against the silicon is brought about.

In still another specific embodiment, the growth of the yttrium-stabilized zirconium dioxide can be controlled with a gradient in the yttrium dioxide concentration of the YSZ layer perpendicular to the layer (plane) for better lattice matching of the yttrium-stabilized zirconium dioxide and of the silicon. This is advantageous if the optimal YSZ composition for ion conductivity and for epitaxial growth on silicon is different.

The epitaxial yttrium-stabilized zirconium dioxide can be applied onto the silicon by pulsed laser deposition or sputtering at low oxygen pressure, i.e. a pressure of less than 0.05 mbar. In particular, here a modification of the oxygen pressure during the deposition process is advantageous. In order to prevent the oxidation of the silicon substrate, a first yttrium-stabilized zirconium dioxide layer should be grown on the silicon with a very low oxygen pressure, or oxygen partial pressure, i.e. less than 10⁻⁵ mbar. After formation of this first YSZ layer on silicon, the oxygen pressure can be increased in order to achieve the required ion-conductive and/or structural properties of the yttrium-stabilized zirconium dioxide.

In yet another specific embodiment, after exposure of the YSZ layer through the removal of a partial region of the YSZ layer, in particular the partial region formerly adjoining the silicon substrate, for example either a YSZ layer having a different composition or yttrium-stabilized zirconium dioxide with diffused-in silicon can be removed.

Finally, the layer can also be grown on an SOI (silicon on insulator) wafer. For example, such an SOI wafer can be obtained by introducing oxygen ions into a silicon wafer that forms the bearer layer. Through ion implantation, it is possible to control the depth (e.g. a few 100 nm) of the region in which the oxygen ions are brought in. In order now to produce a “trenched” silicon dioxide layer, through a high-temperature step the crystal is “healed”; here the introduced oxygen reacts with the silicon (after implantation, mainly at interstitial sites), and forms an insulating layer of silicon dioxide. Alternatively, an insulating layer can be applied on an Si wafer, and subsequently another Si layer, e.g. an epitaxial Si layer, can be deposited thereon. The advantage of growing the layer of the sensor element on an SOI wafer is a possibility of the electrical contacting of the lower porous electrode via the silicon of the bearer layer; the layer is conductive at 500° C., and it is possible to increase the conductivity through an additional doping. This takes place as follows: first, the yttrium-stabilized zirconium dioxide is epitaxially deposited on the bearer layer, i.e. the upper silicon layer of the SOI wafer. Subsequently there takes place the application and the structuring of the upper electrode. A structuring of the yttrium-stabilized zirconium dioxide and of the bearer layer defines the electrical contact of the lower electrode. Subsequently, the YSZ layer is exposed as membrane through the Si/SiO₂/Si. After this, the electrode material of the lower electrode is applied and structured.

The sensor elements produced according to the specific embodiments according to the present invention have a higher ionic conductivity with lower electronic conductivity and higher mechanical stability, compared to conventional microelectrochemical sensor elements having a polycrystalline YSZ layer, because significantly fewer crystal boundaries occur in the YSZ layer. In particular, the ion conductivity parallel to the layer is significantly greater than is the case for polycrystalline or columnar YSZ layers.

Further optional details and features of the present invention result from the following description of exemplary embodiments, shown schematically in the Figures.

### BRIEF DESCRIPTION OF THE DRAWINGS

FIGS. 1A, 1B and 1C show production steps of a method for producing a sensor element according to a first specific embodiment of the present invention.

FIGS. 2A, 2B, 2C and 2D show production tasks of a method for producing a sensor element according to a second specific embodiment of the present invention.

FIG. 3 shows a sensor element according to a third specific embodiment of the present invention.

FIGS. 4A and 4B show method tasks according to a fourth specific embodiment of the present invention.

FIGS. 5A, 5B, 5C, 5D, 5E, and 5F show method tasks for producing a sensor element according to a fifth specific embodiment of the present invention.

### DETAILED DESCRIPTION

The specific embodiments of the present invention described in the following are described fundamentally in the context of a description of the method for producing a sensor element 10 according to the present invention. Here it is to be noted that identical components have been provided with identical reference characters. A sensor element 10 according to the present invention can be used to detect physical and/or chemical properties of a measurement gas, it being possible to acquire one or more properties. In the following, the present invention is described in particular with reference to a qualitative and/or quantitative acquisition of a gas component of the measurement gas, in particular with reference to an acquisition of an oxygen portion in the measurement gas. The oxygen portion can be acquired for example in the form of a partial pressure and/or in the form of a percentage. In principle, however, other types of gas components can be acquired, such as nitrogen oxides, hydrocarbons, and/or hydrogen. Alternatively or in addition, however, other properties of the measurement gas can be acquired. The present invention can be used in particular in the area of motor vehicle technology, so that the measurement gas compartment can particular be an exhaust gas train of an internal combustion engine, and the measurement gas can in particular be an exhaust gas.

Sensor element 10 according to the present invention fundamentally has the design described in the following. Sensor element 10 includes a bearer element 12 and at least one solid electrolyte layer 14. Solid electrolyte layer 14 is situated on bearer element 12. Solid electrolyte layer 14 is fashioned at least partly epitaxially. Bearer element 12 has at least one opening 16, so that solid electrolyte layer 14 has at least one membrane segment 18. Membrane segment 18 is that segment of solid electrolyte layer 14 that is not immediately contacted to bearer element 12. Bearer element 12 can for example be made of silicon. Electrodes (not shown in more detail) are situated on solid electrolyte layer 14. The electrodes are situated on opposite sides of solid electrolyte layer 14. The electrodes are made porous.

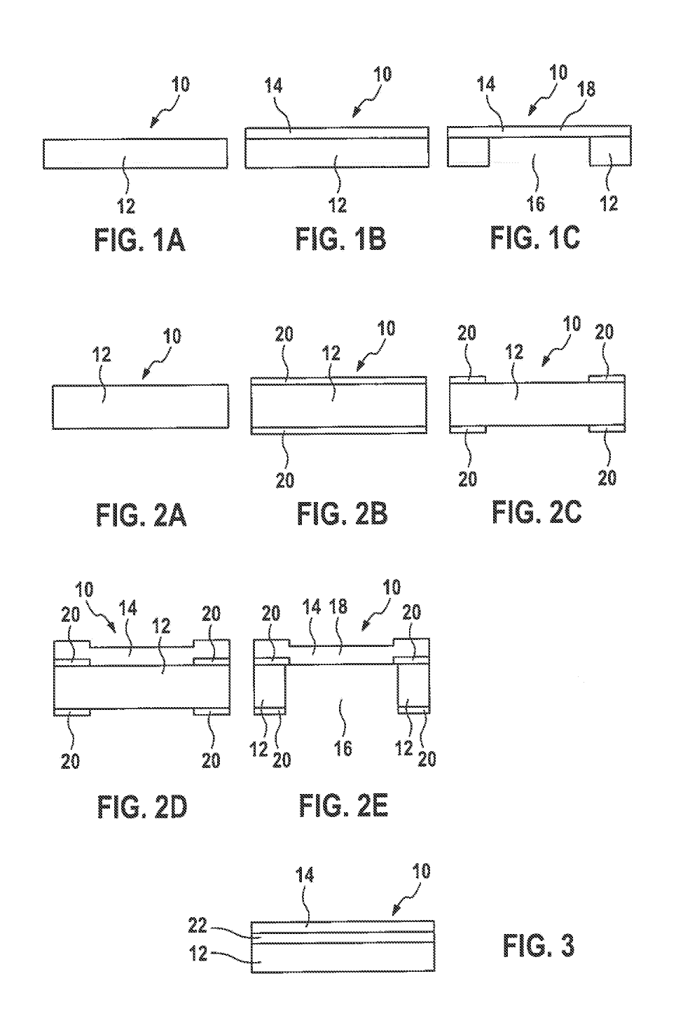

FIGS. 1A-1C show method steps of a method for producing such a sensor element 10 according to a first embodiment of the present invention. FIGS. 1A-1C are side views of sensor element 10. As is shown in FIG. 1A, bearer element 12 is fundamentally provided in a known manner. As is shown in FIG. 1B, the at least one solid electrolyte layer 14 is applied onto bearer element 12 in such a way that solid electrolyte layer 14 is epitaxially formed. For example, solid electrolyte layer 14 is applied onto bearer element 12 by pulsed laser deposition or sputtering. Solid electrolyte layer 14 is in particular applied onto bearer element 12 at a temperature of 800° C. and a pressure of not more than 0.05 mbar. In this way, solid electrolyte layer 14 can be epitaxially formed. Due to the particular type of application using pulsed laser deposition or sputtering, solid electrolyte layer 14 can be applied onto bearer element 12 with a thickness of from 40 nm to 5 μm, which may be 50 nm to 3 μm, particularly 200 nm to 2 μm. As is shown in FIG. 1C, bearer element 12 is subsequently partly removed in such a way that the at least one opening 16 is fashioned such that solid electrolyte layer 14 has the at least one membrane segment 18. The removal of bearer element 12 can take place for example by trenching or etching with caustic potash (KOH).

Here, a direction perpendicular to the layer plane in FIGS. 1A to 1C extends from below to above. In FIGS. 1A to 1C, a direction parallel to the layer plane extends from left to right, and into the image plane.

In the following, a method is described for producing a sensor element 10 according to a second specific embodiment of the present invention, on the basis of FIGS. 2A-2E. FIGS. 2A-2E are side views of sensor element 10. As is shown in FIG. 2A, bearer element 12 is first provided. As is shown in FIG. 2B, at least one insulating layer 20 is applied onto bearer element 12. Insulating layer 20 is produced from at least one electrically insulating material such as silicon nitride (Si₃N₄) or silicon dioxide (SiO₂) In the depicted exemplary embodiment, a respective insulating layer 20 is applied onto both the upper side and the lower side of bearer element 12. The application of insulating layer 20 can also take place by pulsed laser deposition, chemical vapor deposition, or sputtering. As is shown in FIG. 2C, insulating layer 20 is subsequently partly removed, for example by trenching or etching with hydrofluoric acid (HF). Subsequently, as is shown in FIG. 2D, at least one solid electrolyte layer 14 is applied onto bearer element 12 and the remaining segments of insulating layer 20. In this way, insulating layer 20 is situated in segments between solid electrolyte layer 14 and a bearer element 12. In those segments in which solid electrolyte layer 14 is applied onto insulating layer 20, or is situated on insulating layer 20, in this way solid electrolyte layer 14 is made polycrystalline, whereas in those segments in which solid electrolyte layer 14 is applied immediately on bearer element 12, or is situated on bearer element 12, in this way solid electrolyte layer 14 is epitaxially fashioned. The application of solid electrolyte layer 14 can in principle take place as in the first specific embodiment. As is shown in FIG. 2E, opening 16 and membrane segment 18 are subsequently formed, in the manner described in the first specific embodiment. Thus, in the second specific embodiment the use of at least one insulating layer 20 is described at that location of sensor element 10 at which the ion-conducting properties of solid electrolyte layer 14 are not used.

FIG. 3 shows a side view of a layer stack of a sensor element 10 according to a third specific embodiment of the present invention. Sensor element 10 according to the third specific embodiment can be produced as follows. Bearer element 12 is provided as described with reference to the first specific embodiment. At least one intermediate layer 22 is applied onto bearer element 12. This intermediate layer 22 is fashioned epitaxially and so as to be oxidic, electrically conductive, and ion-conducting, or alternatively is fashioned epitaxially and so as to be oxidic and electrically insulating. In order to realize epitaxial, oxidic, electrically conductive, ion-conducting intermediate layer 22, for example La_{0.6}Sr_{0.4}Co_{0.2}Fe_{0.8}O_{3-δ} (LSCF), Sm_{0.5}Sr_{0.5}CoO₃ (SSC), La₁₋ₓSrₓMnO₃ (LSMO) can be used. As material for an epitaxial, oxidic, and electrically insulating layer, for example MgO or SrTiO₃ can be used.

Intermediate layer 22 is applied as is solid electrolyte layer 14 in the way described with regard to the first specific embodiment. Correspondingly, intermediate layer 22 is situated between solid electrolyte layer 14 and bearer element 12. Such an epitaxial and electrically insulating intermediate layer 22 can for example replace the above-described insulating layer 20. Here, solid electrolyte layer 14 is also epitaxially fashioned above intermediate layer 22 or thereon. An epitaxial and ion-conducting intermediate layer 22 is appropriately fashioned only in that region in which membrane segment 18 is fashioned, i.e. between solid electrolyte layer 14 and a porous electrode (not shown in more detail).

In order to arrive at finished sensor element 10, bearer layer 12 is then removed at least in some segments, analogous to FIGS. 1C and 2E.

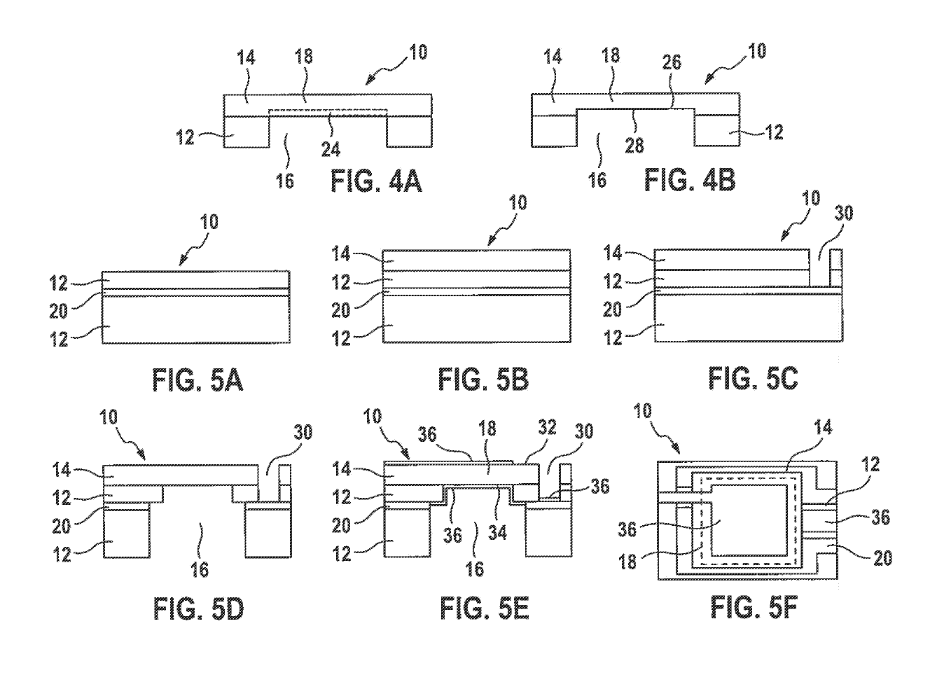

FIGS. 4A and 4B show method steps for producing a sensor element 10 according to a fourth specific embodiment of the present invention. FIGS. 4A and 4B are side views of sensor element 10. FIG. 4A corresponds in principle to the depiction of sensor element 10 according to FIG. 1C. Subsequently, solid electrolyte layer 14 in membrane segment 18 is partly removed. For example, solid electrolyte layer 14 is removed in region 24 outlined by a broken line. The partial removal takes place in such a way that an opening 26 is formed in solid electrolyte layer 14 on a side 28 facing bearer element 12, as is shown in FIG. 4B. Through opening 26, a still-thinner membrane segment 18 can be realized, which however at the same time is stably anchored or fastened on the bearer element due to the greater material thickness.

FIGS. 5A-5F show method steps for producing a sensor element 10 according to a fifth specific embodiment of the present invention. FIGS. 5A-5E are side views of sensor element 10, and FIG. 5F is a top view of sensor element 10. As is shown in FIG. 5A, bearer element 12 is provided. In contrast to the preceding specific embodiments, bearer element 12 is fashioned as an SOI wafer, and thus has a first, or lower, silicon layer, a following, or applied, insulating layer 20, and a second, or upper, silicon layer situated thereon. Bearer element 12 thus includes two silicon layers and insulating layer 20. As is shown in FIG. 5B, solid electrolyte layer 14 is applied onto bearer element 12 in the manner described with regard to the first specific embodiment.

As is shown in FIG. 5C, solid electrolyte layer 14 and the upper silicon layer of bearer element 12 are partly removed. For example, a blind hole recess 30 is made in the upper silicon layer, which penetrates solid electrolyte layer 14 and bearer element 12 to a specified depth. Recess 30 can be made by trenching or etching. Thus, the upper silicon layer of bearer element 12, because it is made of Si, can for example be etched using caustic potash (KOH), whereas solid electrolyte layer 14, if made of YSZ, is etched for example using hydrofluoric acid (HF). Recess 30 ends at insulating layer 20. As is shown in FIG. 5D, opening 16 is then made in the lower silicon layer and in the upper silicon layer of bearer element 12. Insulating layer 20 between the lower silicon layer and the upper silicon layer of bearer element 12 is also removed. Here, opening 16 can also be made tapered in stepped fashion in the direction toward solid electrolyte layer 14. Opening 16 in the upper silicon layer is thus limited at the upper side e.g. by solid electrolyte layer 14 and at the sides by the upper silicon layer. It is made downwardly open. As is shown in FIG. 5E, an electrode 36 can be applied on each of upper side 32, facing away from bearer element 12, and lower side 34, facing bearer element 12, of solid electrolyte layer 14. In addition, a further electrode 36 is introduced into recess 30, for example on the floor of recess 30, and thus on insulating layer 20. Electrode 36 on lower side 34 facing bearer element 12 extends along the upper silicon layer of bearer element 12 inside opening 16, and can thus also be made step-shaped. Electrode 36 on lower side 34 is electrically connected to further electrode 36 in recess 30 via the upper silicon layer of bearer element 12, because the lower silicon layer and the upper silicon layer of bearer element 12 are made of an electrically conductive material. Moreover, further electrode 36 in recess 30 not only contacts insulating layer 20 inside the recess, but also contacts the upper silicon layer, laterally adjacent thereto, of bearer element 12. Thus, a electrode 36 on lower side 34 is connected to electrode 36 in recess 30 via the electrically conductive upper silicon layer of bearer element 12. The two electrodes 36 (on upper side 32 of bearer element 12, and in recess 30) can thus be contacted from the same side of the sensor element.

FIG. 5F shows a sensor element 10 produced in this way. Depicted are electrode 36 on upper side 32 and further electrode 36, situated in recess 30. This specific embodiment offers the possibility that the two electrodes 36, on upper side 32 and on lower side 34 of solid electrolyte layer 14, can be electrically contacted together from the same side. Thus, the contacting of electrodes 36 takes place from upper side 32. The electrical contacting of electrode 36 on lower side 34 is also possible from upper side 32, because recess 30 is provided inside which additional electrode 36 is situated, and that is electrically conductively connected, via the upper silicon layer of bearer element 12, to electrode 36 on lower side 34.

1-10. (canceled)

11. A sensor element for acquiring at least one property of a measurement gas in a measurement gas compartment, comprising:
a bearer element; and
at least one solid electrolyte layer;
wherein the solid electrolyte layer is situated on the bearer element,
wherein the solid electrolyte layer is at least partly epitaxially configured, and
wherein the bearer element has at least one opening, so that the solid electrolyte layer has at least one membrane segment.

12. The sensor element of claim 11, wherein the solid electrolyte layer a thickness of from 40 nm to 5 μm.

13. The sensor element of claim 11, wherein at least one insulating layer is situated in segments between the solid electrolyte layer and the bearer element, and wherein the insulating layer is made of at least one electrically insulating material.

14. The sensor element of claim 11, wherein at least one intermediate layer being situated between the solid electrolyte layer and the bearer element, and wherein the intermediate layer is configured epitaxially so as to be one of: (i) oxidic, electrically conductive, and ion-conducting, and (ii) oxidic and electrically insulating.

15. The sensor element of claim 11, wherein the solid electrolyte layer is made of at least one material that includes zirconium dioxide stabilized with yttrium oxide.

16. The sensor element of claim 11, wherein a portion of the yttrium oxide on the zirconium dioxide has a gradient.

17. The sensor element of claim 11, wherein the solid electrolyte layer in the membrane segment has an opening on a side facing the bearer element.

18. The sensor element of claim 11, wherein an electrode is respectively situated on an upper side, facing away from the bearer element, of the solid electrolyte layer, and on a lower side, facing the bearer element, of the solid electrolyte layer.

19. The sensor element of claim 11, wherein the electrodes are electrically contactable from the same side.

20. A method for producing a sensor element for acquiring at least one property of a measurement gas in a measurement gas compartment, the method comprising:
providing a bearer element;
applying at least one solid electrolyte layer onto the bearer element so that the solid electrolyte layer is at least partially epitaxially configured; and
partially removing the bearer element to form at least one opening so that the solid electrolyte layer has at least one membrane segment.

21. The method of claim 20, wherein the method is for producing a sensor element for acquiring a portion of a gas component in the measurement gas or a temperature of the measurement gas.

22. The sensor element of claim 11, wherein the solid electrolyte layer a thickness of from 50 nm to 3 μm.

23. The sensor element of claim 11, wherein the solid electrolyte layer a thickness of from 200 nm to 2 μm.

24. The sensor element of claim 11, wherein at least one insulating layer is situated in segments between the solid electrolyte layer and the bearer element, and wherein the insulating layer is made of at least one electrically insulating material, in particular at least one of Si₃N₄ and SiO₂.

25. The sensor element of claim 11, wherein a portion of the yttrium oxide on the zirconium dioxide has a gradient, perpendicular to a layer plane of the solid electrolyte layer.

26. The sensor element of claim 11, wherein an electrode, in particular a porous electrode, is respectively situated on an upper side, facing away from the bearer element, of the solid electrolyte layer, and on a lower side, facing the bearer element, of the solid electrolyte layer.

27. The sensor element of claim 11, wherein the sensor element is for acquiring a portion of a gas component in the measurement gas or a temperature of the measurement gas.
